(19) United States
(12) Patent Application Publication
(10) Pub. No.: US 2012/0290317 A1
(43) Pub. Date: Nov. 15, 2012

(54) TOOL FOR CLINICAL DATA MINING AND ANALYSIS

(76) Inventors: Rajesh Nair, Princeton, NJ (US); Sanjay Parikh, Mumbai (IN)

(21) Appl. No.: 13/522,711

(22) PCT Filed: Jan. 21, 2011
(86) PCT No.: PCT/IB11/50269

§ 371 Date: Jul. 17, 2012

(30) Foreign Application Priority Data
Jan. 21, 2010 (IN) 142/CHE/2010

(51) Int. Cl. G06Q 50/22

(52) U.S. Cl. 705/2

(57) ABSTRACT

In one aspect, the invention provides a clinical trial information management tool. The tool comprises an interface with a multiple tagged clinical trial database; a user interface for receiving user inputs, a search engine to query the multiple tagged clinical trial database in one or more levels based on user inputs; a display platform to display results from the query in one or more views; an analytics engine to provide at least one of parameter based analysis and graphical analysis; and a personalization platform to store the query and the results. The tool provides the advantage through the rapid, facile and user-friendly manner in which clinical trial information from a wide variety of sources may be searched, analyzed and reported by a user, which allows for easy strategizing regarding clinical trial related matters, among other unique advantages.

### TECHNICAL FIELD

The invention relates generally to clinical trial management and more specifically to a tool for clinical trial data mining and analysis.

### BACKGROUND

In the medical field, clinical trials are typically conducted to allow safety and efficacy data to be collected for drugs, diagnostics, devices, therapy protocols, and other health or disease management related aspects. There are details procedures that need to be followed by corporates, research or health organizations to plan and conduct the trials for any new and/or development phase drugs, diagnostics, devices, therapy protocols, etc. The trial planning involves selection of the sites or centres where the trial would be conducted, these could be single center in one country or multiple centers in different countries. Similarly, there is a choice of healthy volunteers and/or patients depending on the type of product for which clinical trial is being conducted. Besides these, there are elaborate lab procedures that need to be selected for the clinical trials.

Clinical trials thus involve efficient planning and huge costs for all of the above mentioned activities, and design of clinical trials is critical to ensure that one gets relevant results for the product being tested. Clinical trials are also usually required before the national regulatory authority approves marketing of the drug or device, or a new dose of the drug, for use on patients.

The information from the ongoing and completed clinical trials is therefore very valuable to all those who may be engaged in similar research efforts for effective new clinical trial design. Currently the information pertaining to clinical trials is available from discrete information sources. An indicative list of such information sources include public domain sources like the website www. Clinicaltrials.gov, World Health Organization's clinical trial registry, and country specific clinical trial registry like Indian clinical trial registry, Sri Lankan clinical trial registry etc.; a company specific clinical trial registry like Glaxo SmithKline clinical trial registry, Roche clinical trial registry, etc.; and literature resources like PubMed, conference abstracts, and the like. The clinical trial data currently available is huge and widely dispersed.

There have been some inter-governmental efforts to provide a portal to access clinical trial information from select databases, for example the IFPMA Clinical Trial Portal that provides links to ClinicalStudyResults.org, ClinicalTrials.gov, Current Controlled Trials, Japan Pharmaceutical Information Center, and Pharmaceutical Industry Clinical Trials database. However, these efforts currently lack integration of all the different sources of information and the search features are limited.

Therefore there is a continuing need to address issues related to accessing clinical data information from all the different sources with ease and analyzing the data to find out the progress of any trial or results therefrom.

Accordingly there is a need to have a single window platform that is able to access all the different information sources and provide usable information on time and with speed.

### BRIEF DESCRIPTION

In one aspect, the invention provides a clinical trial information management tool, wherein the tool comprises an interface with a multiple tagged clinical trial database; a user interface for receiving user inputs, a search engine to query the multiple tagged clinical trial database in one or more levels based on user inputs; a display platform to display results from the query in one or more views; an analytics engine to provide at least one of parameter based analysis and graphical analysis; and a personalization platform to store the query and the results.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of the tool for clinical trial data mining and analysis;

FIG. 2 is an exemplary view showing different features for the tool of FIG. 1;

FIG. 3-7 are different exemplary views that show the different search options provided by a search engine of the tool of FIG. 1;

FIG. 8-11 are different exemplary representative views provided by an analytics engine and displayed through a display platform of the tool of FIG. 1;

FIG. 12 is an exemplary view showing cluster of different trial sites in a geography map view;

FIG. 13 is an exemplary view showing details of individual trial sites in the geography map view;

FIG. 14 is an exemplary view for selecting parameter based analysis or graphical analysis;

FIG. 15 is an exemplary view for an output parameter based analysis;

FIG. 16 is an exemplary view for competive and individual landscapes provided by the analytics engine of the tool of FIG. 1;

FIG. 17 is an exemplary snapshot view for options for a competitive landscape representation;

FIG. 18 is an exemplary views for competitive landscapes based on the selection opted for in the view shown in FIG. 17;

FIG. 19 is an exemplary view for options for an individual landscape representation;

FIG. 20 is an exemplary views for individual landscapes based on the selection opted for in the view shown in FIG. 19;

FIG. 21 is an exemplary view for selection of options provided by the personalization engine of the tool of FIG. 1; and

FIG. 22 is an exemplary view for an email alert feature for any ongoing or future trials, provided by the tool of FIG. 1.

### DETAILED DESCRIPTION

As used herein and in the claims, the singular forms “a,” “an,” and “the” include the plural reference unless the context clearly indicates otherwise.

The clinical trial, or simply trials herein, refers to a health intervention study and includes but is not limited to studies related to drugs, devices, dosages, therapy protocols, diagnostics.

As used herein the clinical trial data is data or information available at any time point after initiation of a clinical trial including clinical study design. As one of ordinary skill in the art will appreciate, different data will become available at different stages of clinical trials, all of which are meant to be included as clinical trial data. Thus, for example, a clinical study design alone may be clinical trial data, or in the middle of a clinical trial, data such as investigators, geography, experimental details, and the like will constitute clinical trial data, while at the completion of a clinical trial, data such as results, end points, and so on will also be included as part of clinical trial data.

The clinical trial management as used herein refers to management of clinical trials. The management of clinical trial is achieved using the clinical trial data as defined herein.

The indication area as used herein refers to a condition which makes a particular treatment or procedure advisable.

The non-indication parameters as used herein refer to parameters, which are seen across the clinical trials irrespective of indication area the trial was conducted. Thus the non-indication parameters are independent of an indication area.

The exemplary but non-limiting non-indication parameters include Trial Phase, Trial Status, Study design, Race, Gender, Age, Study sponsor, Investigator, Trial Site, Drug, Treatment duration, and Intervention type. A sample list of non-indication parameters is given in Table 1.

TABLE 1

| | Trial | |
|---|---|---|
| Trial Phase | Status | Study Type |
| 1. Phase I | Planned | 1. Interventional Study |
| 2. Phase I/II | Open | 2. Observational Study |
| 3. Phase II | Closed | 3. Dose Optimization/Dose Consolidation Study |
| 4. Phase | Com- | 4. Dose Titration Study |
| II/III | pleted | 5. Investigator-Initiated Study |
| 5. Phase III | Tempo- | 6. Extension Study |
| 6. Phase | rarily | 7. Pharmacoeconomics Study (HE&OR Study) |
| III/IV | Closed | 8. Pharmacogenomics/Pharmacogenetics Study |
| 7. Phase IV | Termi- | 9. Pilot Trial |
| | nated | 10. Pivotal Trial |
| | | 11. Postmarketing Surveillance (PMS) Study |
| | | 12. Proof-of-concept (POC) Study |
| | | 13. Registry Study |

The indication parameters as used herein refer to parameters that are specific for a given indication area. Some exemplary but non-limiting indication parameters include a Disease condition, Patient segment, Inclusion criteria, Exclusion criteria, Endpoints—Efficacy & Safety, and Diagnostic and Laboratory parameters.

Indication parameters may be further subdivided into sub-parameters. For example, sub-parameters for an indication parameter pulmonary disease may be bronchitis. It will be understood by one skilled in the art that an indication parameter in one situation may be a sub-parameter in another situation and/or study. Thus, in another exemplary embodiment, the indication parameter is bronchitis and the sub-parameter is chronic obstructive pulmonary disease with gastrointestinal disorders. Also, in some exemplary embodiments, the indication parameter may not have any sub-parameters at all.

A sample of the Chronic Obstructive Pulmonary Disorder (COPD) indication parameter and sub-parameters is listed in the Table 2 below:

TABLE 2

| Main Parameter | Sub-Parameter |
|---|---|
| Chronic Obstructive | 1. Emphysema |
| Pulmonary Disease | 2. Chronic Bronchitis |
| | 3. Stable Chronic Obstructive Pulmonary |
| | Disease |
| | 4. Symptomatic Chronic Obstructive |
| | Pulmonary Disease |
| | 5. Poorly Reversible Chronic Obstructive |
| | Pulmonary Disease |
| | 6. Partially Reversible Chronic Obstructive |
| | Pulmonary Disease |
| GOLD Stage 1/Mild | |
| Chronic Obstructive | |
| Pulmonary Disease | |
| GOLD Stage 2/Moderate | |
| Chronic Obstructive | |
| Pulmonary Disease | |
| GOLD Stage 3/Severe | |
| Chronic Obstructive | |
| Pulmonary Disease | |
| GOLD Stage 4/Very Severe | |
| Chronic Obstructive | |
| Pulmonary Disease | |
| Chronic Obstructive | 1. COPD with Asthma |
| Pulmonary Disease with | 2. COPD with Pulmonary Hypertension |
| Comorbid Conditions | 3. COPD with Hypertension |
| | 4. COPD with Coronary Heart Disease |
| | 5. COPD with Congestive Heart Failure |
| | 6. COPD with Chronic Cor Pulmonale |
| | 7. COPD with Gastrointestinal Disorders |
| | 8. COPD with Hypogonadism |
| | 9. COPD with Chronic Renal Failure (CRF) |
| Alpha-1 Proteinase | |
| Inhibitor Deficiency | |
| Asthma | |
| Asthma with Comorbid | 1. Asthma with Hypertension |
| Conditions | 2. Asthma with Coronary Heart Disease |
| Lung Transplant Patients | |
| Healthy Smokers | |
| Healthy Nonsmokers/ | |
| Ex-Smokers | |
| Healthy Volunteers | 1. Healthy Male Volunteers |
| | 2. Healthy Female Volunteers |
| Others | 1. COPD with Insomnia |
| | 2. Cystic Fibrosis |
| | 3. Patients with Gastroduodenal ulcer |
| | 4. Idiopathic Pulmonary Fibrosis (IPF) |
| | 5. Unspecified Chronic Respiratory Disease |
| | 6. Cigarette Smokers |
| | 7. Active SELECT trial Participant |

In another exemplary embodiment, the indication parameter is an inclusion criterion and an exemplary list for the same is given in Table 3:

TABLE 3

| Sl. | | |
|---|---|---|
| No. | Parameter | Sub Parameter |
| 1 | COPD | |
| 2 | Mild COPD/GOLD Stage 1 | |
| 3 | Moderate COPD/GOLD Stage 2 | |
| 4 | Severe COPD/GOLD Stage 3 | |
| 5 | Very Severe COPD/GOLD Stage 4 | |
| 6 | Patients with positive | |
| | bronchodilator reversibility | |
| 7 | Patients with negative | |
| | bronchodilator reversibility | |
| 8 | Obese subjects | Overweight subjects (Grade |
| | | 1 obesity, BMI = 25 to 29.9) |
| | | Obese subjects (Grade 2 |
| | | obesity, BMI = 30 to 39.9) |
| | | Morbid obesity (Grade 3 |
| | | obesity, BMI = 40) |
| 8 | Subjects with hypoxaemia | Hypoxaemia at rest |
| | | Hypoxaemia on exercise |
| 9 | Subjects with hyperinflated lungs | |
| 10 | Symptomatic COPD | |
| 11 | Stable COPD | |
| 12 | Hospitalized patients | |
| 13 | Outpatients | |
| 14 | Acute exacerbation of COPD | |
| 15 | Patients with Emphysema | |
| 16 | Patients with Alpha-1 AT | |
| | deficiency | |
| 17 | Patients with Chronic bronchitis | |
| 18 | Smokers/Subjects with a history | Current Smokers |
| | of smoking | Ex-Smokers |
| | | History of <10 pack years |
| | | History of > or = 10 |
| | | pack years |
| | | History of > or = 15 |
| | | pack years |
| | | History of > or = 20 |
| | | pack years |
| 19 | COPD patients with history of | Frequent exacerbations |
| | exacerbations | At least one exacerbation |
| | | within the past 1 year |
| | | Two or more exacerbations |
| | | within the past 1 year |
| | | At least one exacerbation |
| | | in past 2 years |
| | | At least two exacerbations |
| | | in past 2 years |
| | | At least one severe |
| | | exacerbation (requiring |
| | | hospitalization) in past |
| | | 2 years |
| 20 | Patients currently receiving | Bronchodilators |
| | or with a history of receiving | Beta-2 agonists |
| | COPD therapy | Anti-cholinergics |
| | | Short-acting beta-2 |
| | | agonists plus |
| | | anticholinergics |
| | | Methylxanthines |
| | | Corticosteroids |
| | | Inhaled corticosteroids |
| | | Systemic corticosteroids |
| | | Inhaled LABA plus |
| | | Corticosteroids |
| | | Stable COPD medication |
| | | Oxygen therapy |
| | | Pulmonary rehabilitation |
| | | Patients on mechanical |
| | | ventilation |

Similarly another list of exclusion parameters as used in the invention is given below in Table 4.

TABLE 4

| Sl. | | |
|---|---|---|
| No. | Parameter | Sub Parameter |
| 1 | Mild COPD/GOLD stage 1 | |
| 2 | Moderate COPD/GOLD stage 2 | |
| 3 | Severe COPD/GOLD stage 3 | |
| 4 | Very severe COPD/GOLD stage 4 | |
| 5 | Alpha-1 AT deficiency | |
| 6 | Poorly controlled COPD | Unstable COPD |
| | | Recent change in COPD |
| | | medication |
| | | Recent hospitalisation |
| | | due to COPD |
| 7 | Acute exacerbation of COPD | |
| | (AECOPD) | |
| 8 | History of COPD exacerbations | |
| 9 | History of life-threatening | |
| | pulmonary obstruction/ | |
| | exacerbation of COPD | |
| 10 | Hypoxaemia | Hypoxemia at rest |
| | | Hypoxemia during exercise |
| | | Hypoxemia on supplemental |
| | | oxygen |
| 11 | Pulmonary disease/condition | Bronchiectasis |
| | other than COPD | Asthma |
| | | Cystic fibrosis |
| | | Giant bullous disease |
| | | Interstitial lung disease |
| | | Lung cancer |
| | | Pleural pathology |
| | | Pneumonia |
| | | Pneumothorax |
| | | Primary ciliary dyskinesia |
| | | Pulmonary edema |
| | | Pulmonary fibrosis |
| | | Pulmonary hypertension |
| | | Pulmonary thromboembolic |
| | | disease |
| | | Sarcoidosis |
| | | Solitary nodule in the lung |
| | | Tuberculosis (known, active) |
| | | Tuberculosis sequalae |
| | | Unspecified chronic |
| | | respiratory disease |
| | | Chest x-ray abnormality |
| | | other than COPD |
| | | Pneumoconiosis |
| 12 | Patients with hematologic | |
| | disorder | |
| 13 | Bladder neck obstruction | |
| 14 | Immune disorder | |
| 15 | Neoplasm | Cancers |
| | | Cancers with specific |
| | | exceptions |
| 16 | Infections | |
| 17 | Ophthalmic disease | |
| 18 | Neurological disease | |
| 19 | Psychiatric disorder | Bipolar disease |
| | | Schizophrenia |
| | | Mental retardation |

An exemplary list of end-points as used in the method of the invention is given below in Table 5:

TABLE 5

| Sl. | | |
|---|---|---|
| No. | Parameter | Sub Parameter |
| 1 | Forced Expiratory Volume | FEV1 AUC |
| | in One Second (FEV1) | FEV1 Peak |
| | | FEV1 Trough |
| | | FEV1 PostBronchodilator |
| | | FEV1 PreBronchodilator |
| | | Serial FEV1 |
| 2 | Forced Inspiratory Volume | FIV1 PreBronchodilator |
| | in One Second (FIV1) | FIV1 PostBronchodilator |
| 3 | Forced Vital Capacity | FVC AUC |
| | (FVC) | FVC Peak |
| | | FVC Trough |
| | | FVC PostBronchodilator |
| | | FVC PreBronchodilator |
| | | Serial FVC |
| 4 | FEV1/FVC Ratio | |
| 5 | Peak Expiratory Flow Rate | Home PEFR |
| | (PEFR) | Clinic PEFR |
| | | Morning/AM PEFR |
| | | Evening/PM PEFR |
| | | PEFR PreBronchodilator |
| | | PEFR PostBronchodilator |
| 6 | Expiratory/Inspiratory | Maximum Expiratory Flow (MEF) |
| | Flow | Maximum Mid-Expiratory Flow |
| | | (MMEF) |
| | | Forced Expiratory Flow (FEF) |
| | | Peak Inspiratory Flow |
| | | Expiratory flow-limitation by |
| | | Forced oscillation technique |
| | | Peak Expiratory Flow |
| 7 | Inspiratory Capacity | IC Peak |
| | (IC) | IC Trough |
| | | IC at Rest |
| | | IC During Exercise |
| | | Isotime and Peak Exercise IC |
| | | End-of-Exercise IC |
| | | IC PreBronchodilator |
| | | IC PostBronchodilator |
| | | Hyperinflation |
| | | Static Inspiratory Capacity |
| 8 | Functional Residual | Predicted Functional Residual |
| | Capacity (FRC) | Capacity (FRC) |
| | | FRC PreBronchodilator |
| | | FRC PostBronchodilator |
| 9 | Vital capacity (VC) | Slow Vital Capacity (SVC) |
| | | Inspiratory Vital Capacity (IVC) |

Another exemplary list of indication parameters showing diagnostic/lab parameter is given in Table 6 below:

TABLE 6

| Parameter | Sub Parameter |
|---|---|
| Forced Expiratory Volume | FEV1 AUC |
| in One Second (FEVl) | FEV1 Peak |
| | FEV1 Trough |
| | FEV1 PostBronchodilator |
| | FEV1 PreBronchodilator |
| | Serial FEV1 |
| Forced Inspiratory Volume | FIV1 PreBronchodilator |
| in One Second (FIV1) | FIV1 PostBronchodilator |
| Forced Vital Capacity | FVC AUC |
| (FVC) | FVC Peak |
| | FVC Trough |
| | FVC PostBronchodilator |
| | FVC PreBronchodilator |
| | Serial FVC |
| FEV1/FVC Ratio | |
| Peak Expiratory Flow | Home PEFR |
| Rate (PEFR) | Clinic PEFR |
| | Morning/AM PEFR |
| | Evening/PM PEFR |
| | PEFR PreBronchodilator |
| | PEFR PostBronchodilator |
| Expiratory/Inspiratory | Maximum Expiratory Flow (MEF) |
| Flow | Maximum Mid-Expiratory Flow (MMEF) |
| | Forced Expiratory Flow (FEF) |
| | Peak Inspiratory Flow |
| Inspiratory Capacity | IC Peak |
| (IC) | IC Trough |
| | IC at Rest |
| | IC During Exercise |
| | Isotime and Peak Exercise IC |
| | IC PreBronchodilator |
| | IC PostBronchodilator |
| Vital capacity (VC) | Slow Vital Capacity (SVC) |
| Lung Volumes | Total Lung Capacity (TLC) |
| | Residual Volume (RV) |
| | Residual volume/Total Lung Capacity |
| | (RV/TLC) |
| | Functional Residual Capacity (FRC) |
| | Expiratory reserve volume (ERV) |
| | Tidal Volume (VT) |

It will be appreciated by those skilled in the art that only exemplary lists are shown in above tables, and the lists include several other parameters needed for classification and tagging of the clinical trials.

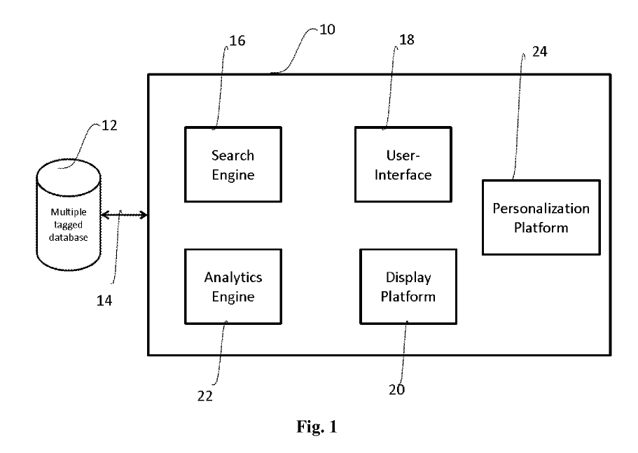

Now turning to drawings, FIG. 1 is a diagrammatic representation of a tool for clinical data mining and analysis, according to an aspect of the invention. The tool 10 comprises using a multiple tagged clinical trial data embodied in a multiple tagged database 12 through an interface 14. The multiple tagged clinical trial data is a set of clinical trial data that has been collated and tagged with standardized representative keywords for both indication and non-indication parameters, such that it facilitates searching and analysis. The multiple tagged clinical trial data set is obtained by following a series of steps. Some exemplary steps involved in providing multiple tagged clinical trial data include collecting clinical trial information, removing redundancies from the collected clinical trial information to provide collated clinical trial information, tagging the collated clinical trial information with non-indication parameters to provide a first cut tagged information, and subsequently tagging the first cut tagged information with indication parameters to provide multiple tagged clinical trial data, and then creating a multiple tagged database of multiple tagged data.

As indicated herein, tagging of the collated clinical trial data is done at two levels. Baseline tagging of the collated clinical data is then done using non-indication parameters to provide a first cut tagged information.

A second level of tagging is done using a disease specific list of indication parameters, wherein the indication parameters are classified into main indication parameters and sub indication parameters.

The steps involved in creating a list of indication parameters in an exemplary embodiment involves, collating all the clinical trials in a given indication area and listing down all the data pertaining to given parameter. For example, for endpoints, all the endpoints that are used in all the clinical trials collated are listed. Next, filtering is done to remove the redundant indication data. Next, the data collected pertaining to given parameter, is divided into different level, for example, two levels, first level being termed as indication parameter, sometimes also referred to as Main parameter (also sometimes referred to as parent parameter) and second level being sometimes termed as Sub-parameter (also sometimes referred to as child parameter).

Thus, all the relevant trials are thus categorized, analyzed and indexed based on parameters that depend on a given indication area. Then using the baseline tagging and advanced tagging, the multiple tagged clinical data is created.

One skilled in the art will appreciate that clinical trial information is constantly updated, and newer fragments of data are constantly being provided from one or more sources given herein. Hence, in one embodiment, the tool of the invention allows for dynamic updating of the trial data information. In this respect the mapping a new clinical trial information to an existing multiple tagged clinical data or creating a new multiple tagged clinical data from the new clinical trial information, if it is not an update for any existing record but a new trial data is also allowed for in the tool of the invention.

Referring again to FIG. 1, the tool uses the multiple tagged database 12 in its search and analytics operations through a search engine 16 and an analytics engine 22 respectively that will be discussed in more detail herein below. The tool further comprises a user-interface 18 for enabling a user to input a search query for querying the enhanced clinical trial database using a number of different search options through a search engine 16, as well to view the results or the output from a display platform 20. Additionally, the tool 10 comprises a personalization platform 24 that is used by the user to save and store the search and display data as per user's interest and requirements. The different aspects of each of these components of the tool are discussed in more detail in reference to the subsequent drawings which are exemplary snapshot view of some of the exemplary but non-limiting features of the tool.

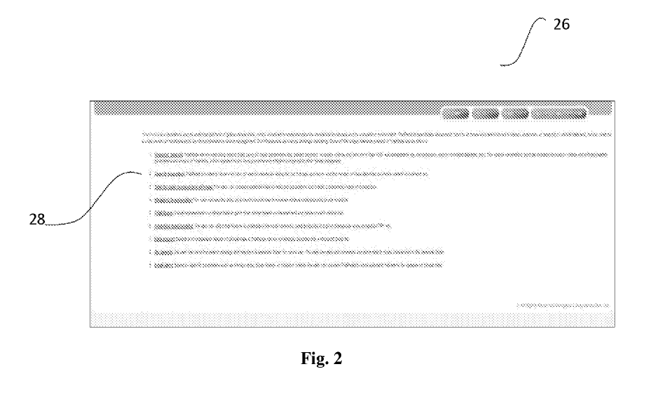

FIG. 2 is a screenshot view 26 of the different features indicated generally by reference numeral 28, for the tool 10 of FIG. 1. Some of these include for example, granular search option, a search snapshot, a side-by-side comparison of trials, a mapping by geography functionality, trial maps, analytics functionality, data export feature, personalization feature and an email alert option.

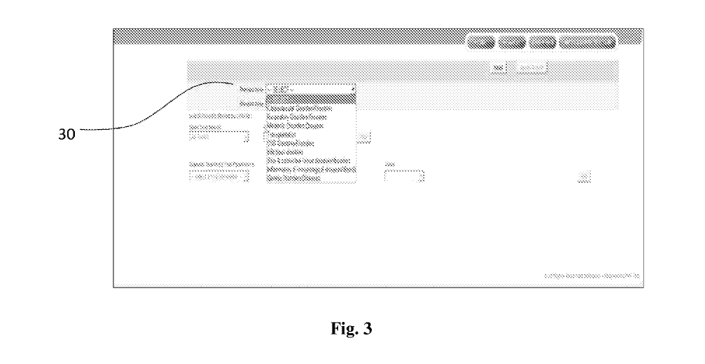

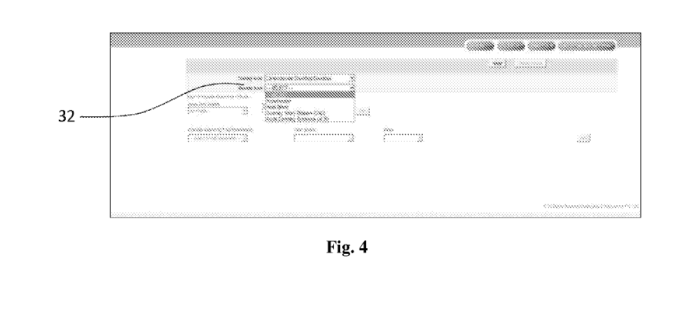

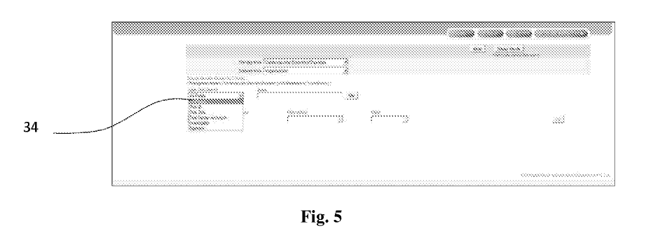

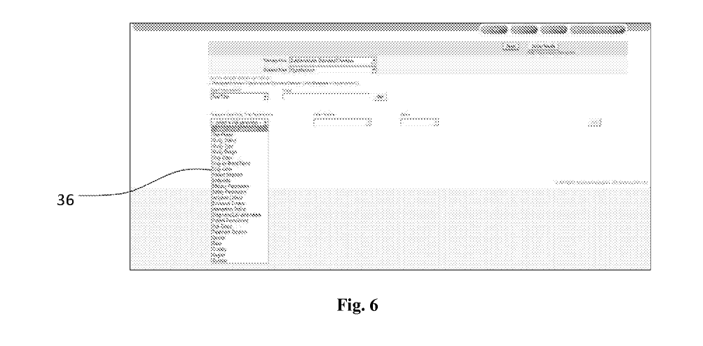

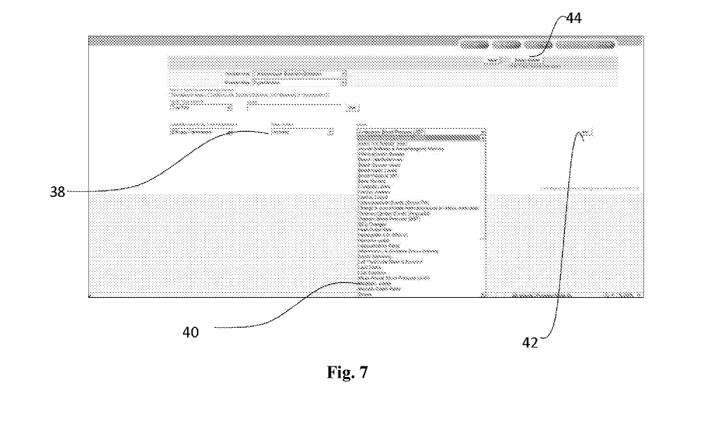

FIG. 3-7 showcase some exemplary but non limiting searching options by using the search engine 16. At least one of the search options for the search engine, includes using indication area, as shown in FIG. 3 and FIG. 4 by reference numerals 30 and 32 respectively that show the therapy area and the disease area that can be selected through a drop down menu. Further, trial may be searched through a generic index for example as shown in FIG. 5 by the reference numeral 34, where Trial ID, Trial Title, Investigator, Sponsor etc may be selected. Further, the querying as mentioned herein above may be done by choosing at least one selectable field, where the at least one selectable field includes at least one indication parameter as shown in FIG. 6 through the menu 36. As mentioned herein above, the indication parameters may be selected from the indication specific list that would be available to user as a drop down menu or similar representation. Search fields may include non-indication parameters also as shown in FIG. 6. Thus, the search query may be given as a drop-down menu or may be typed in a field as an input. One of ordinary skill in the art will appreciate that when the search text is input, it may be given as a single word or as a complete phrase, or even a complete sentence. A combination of a selection from a drop-down menu and typed in text may also be given. All of these may be referred to in the art as search query. Once a particular indication parameter is given or chosen or both, the sub-parameter associated with the main parameter is given as a choice for the user to choose from to further narrow down the search, as shown in FIG. 7 by reference numeral 38 and 40. Once a search query is provided, the tool of the invention queries the relevant clinical trial information in the enhanced clinical trial database and provides the search results as indicated by reference numeral 44. Thus, the tool further includes a user interface for displaying the search results.

As mentioned herein above, the search may thus be executed by selecting a therapy area and/or by disease area. Further the search results may be filtered by open text search by selecting any one of the options like Trial ID, Title, Investigator, Sponsor. A further refinement or a granular search may be done using trial parameters, filtering for inclusion or exclusion of selected trial parameters, and further selection of the selected parameter. The search engine further provides the ability to be queried by adding more search parameters by using boolean operators like OR and AND operator as indicated by reference numeral 42 in FIG. 7.

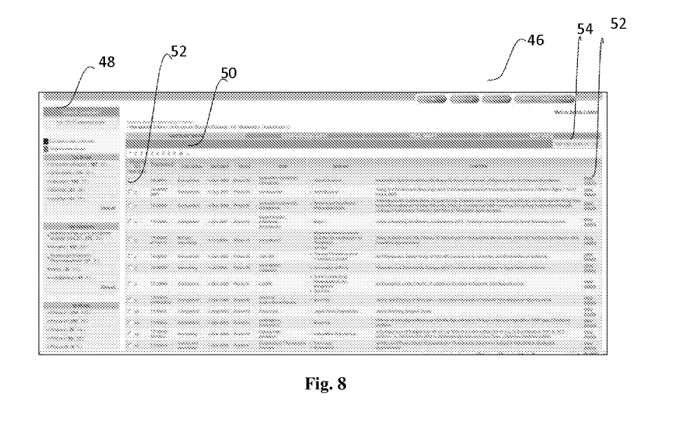

Further, as mentioned in reference with FIG. 1, the tool provides a display platform 20 to display of relevant clinical trial information based on user query, including display in the form of comparative view, graphical view, tabular view, geographical distribution view etc., as shown in FIG. 8 and indicated generally by reference numeral 46. For example, the analytical representations include a tabular view, a comparison view, a map view, a dashboard view, a graphical view, a competitive landscape view, and a single level analysis view. These different forms of analytical representation are very useful to any user seeking the trial information to make useful interpretations and decisions based on such information. Further these analytical representations may also be a family of representations, for example the competitive landscape view can include at least an endpoint based competitive landscape and an individual indication parameter based competitive landscape. The user-interface is also advantageously used by a user for dynamically selecting one or more analytical representations from the variety of analytical representations that are made available to the user through this method.

Each of these views are generated using an analyses technique. In the exemplary embodiment, one of the views is a snapshot view as indicated by reference numeral 48 that is a visual overview of search results by listing the top five drugs, sponsors, and the number of trials identified by phase, patient recruitment, etc.

An exemplary tabular view is shown by reference numeral 50 which has further selection and viewing options as indicated by reference numerals 52. Further an export to excel feature is provided as indicated by reference numeral 54.

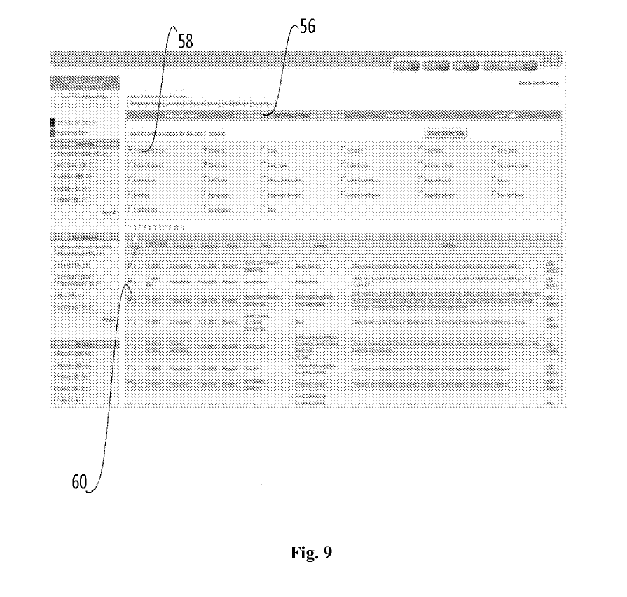

Another display option is a side-by-side comparison of trials in which the user can compare selected trials by selected parameters and create a customized table of comparison. An exemplary depiction of comparison view is shown in FIG. 9 as indicated by reference numeral 56. Difference search options are provides to select therapy area, diseases, drugs etc as indicated by reference numeral 58, and further refined selection is provided as indicated by reference numeral 60.

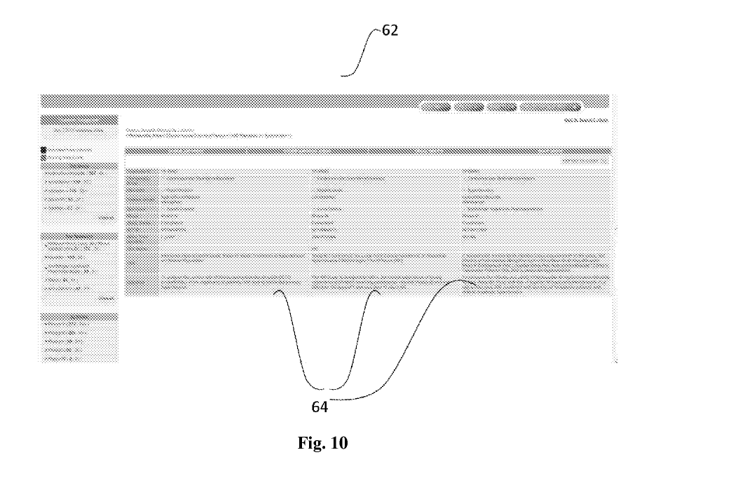

FIG. 10 shows an exemplary side by side comparison view as indicated by reference numeral 60 based on the selection done in the previous view of FIG. 9.

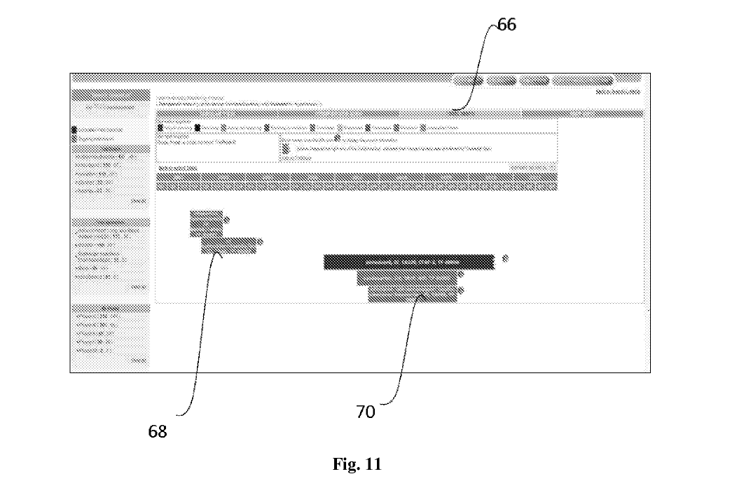

The trial map view as shown in FIG. 11 by reference numeral 66 is another useful visual representation of clinical trials in gantt chart format based on the start and end dates of each clinical trial as depicted by reference numerals 68 and 70.

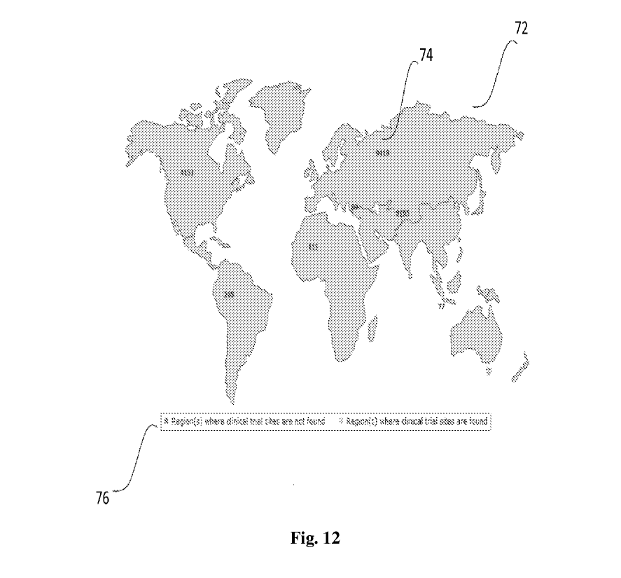

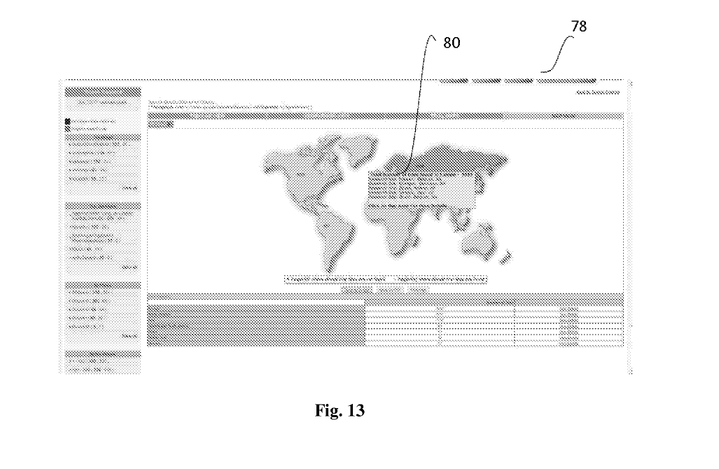

The geography map view as shown in FIG. 12 and indicated generally by reference number 72 allows the user to see the sites on a country/world map as indicated by reference numeral 74 to have an intuitive understanding of site locations. The geography map view shows both the regions where the trial sites are found and not found, as indicated by reference numeral 76. Further as shown in view 78 in FIG. 13, more details for each site can be found in an exemplary embodiment, where country wise site information may be provided, as indicated by reference numeral 80.

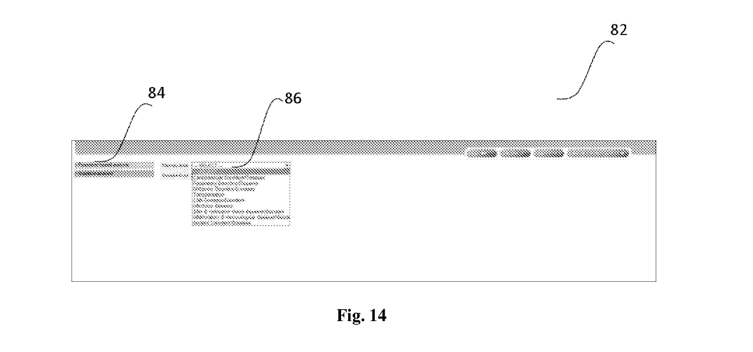

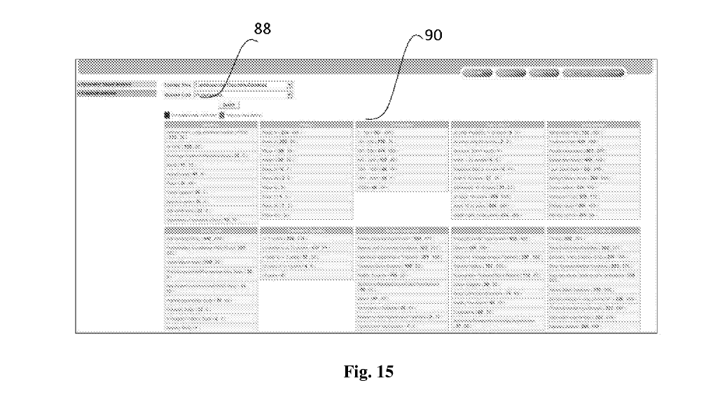

As mentioned herein above, the tool includes an analytics engine 22 (FIG. 1) to analyze the multiple tagged clinical data and select relevant clinical trial information based on search query and predefined analysis conditions. Besides the different analytical representations shown in FIG. 8-13, the tool provides parameter based analysis and graphical analysis as shown in FIG. 14, generally by reference numeral 82. The parameter based analysis as indicated by reference numeral 84 provides for searching by therapy area and disease are as indicated by reference numeral 86. The output of parameter based analysis is shown in FIG. 15 by reference numeral 90 that provides a parametric analysis of all the trial data organized in a meaningful manner.

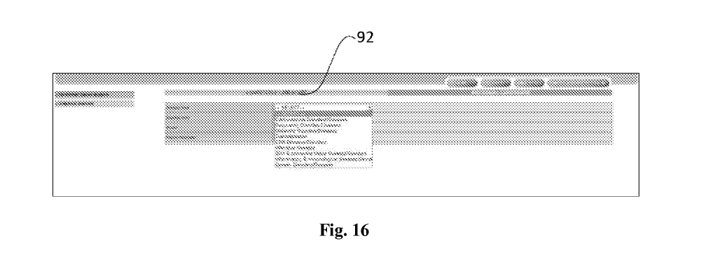

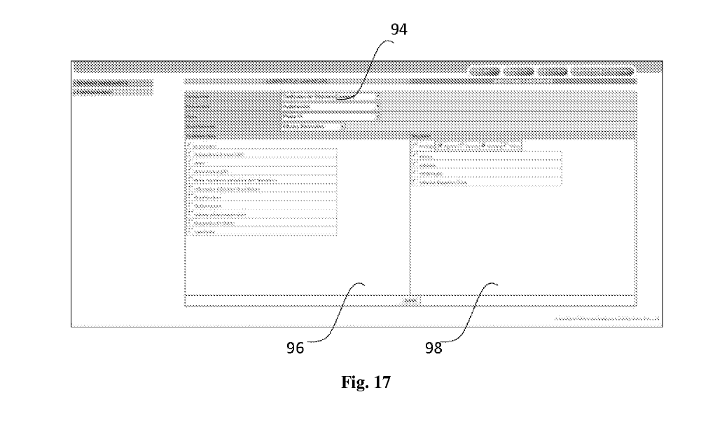

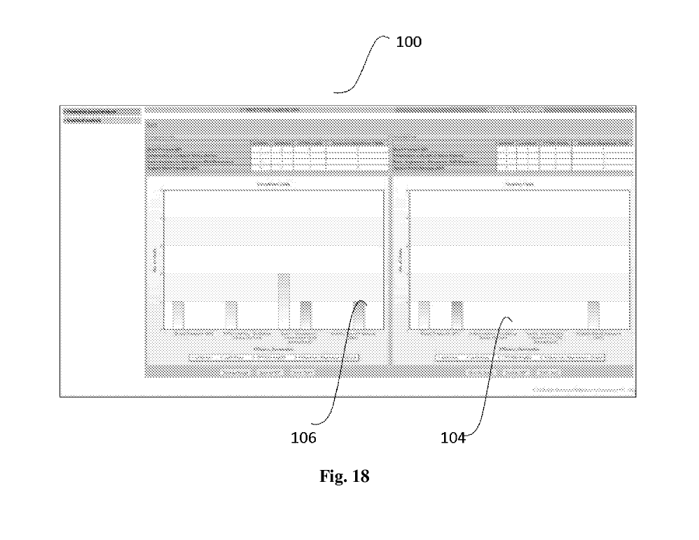

The tool of the invention provides for the advantage of allowing the user to understand the most commonly used endpoints in a given therapeutic area, competitor target product profile (also abbreviated sometimes in the art as TPP), etc. through the parameter based analysis and graphical analysis. The analytics engine also provides a competitive landscape and individual landscape as shown in FIG. 16 and shown generally by reference numeral 92. FIG. 17 shows the competitive landscape selection options as shown by reference numerals 94, 96 and 98 and FIG. 18 shows the competitive landscape views depicted generally by 100, and the specific views being depicted by reference numeral 104 and 106.

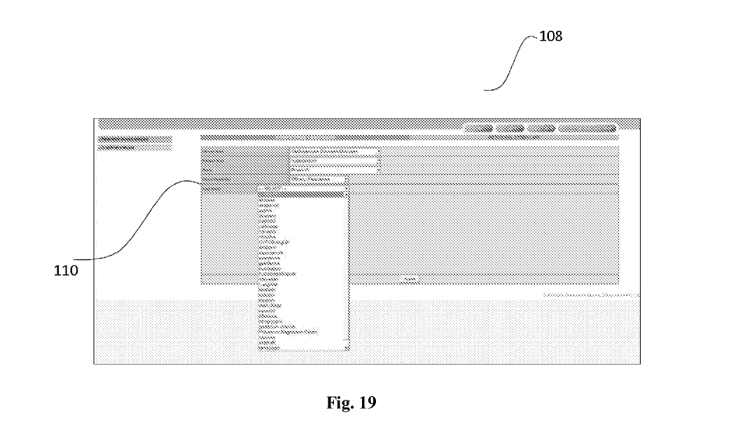

FIG. 19 shows the individual landscape option though the view 108. The different selection options are provided for the user as shown generally by reference numeral 110 to choose the therapy area, disease are, phase, parameter and the drug for which the individual landscape is sought.

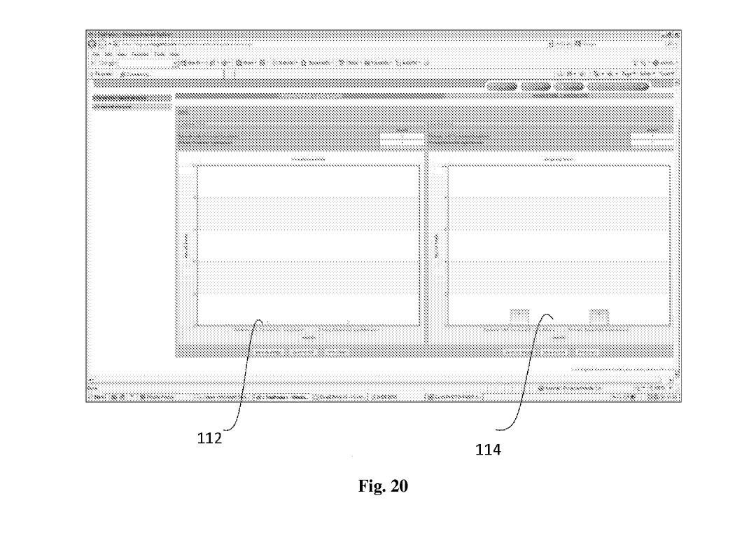

FIG. 20 shows the individual landscape views 112 and 114 based on the selection done in the view shown in FIG. 19. Various option to save these landscape views are also provided in an exemplary embodiment including saving as image, saving as a pdf or as a chart.

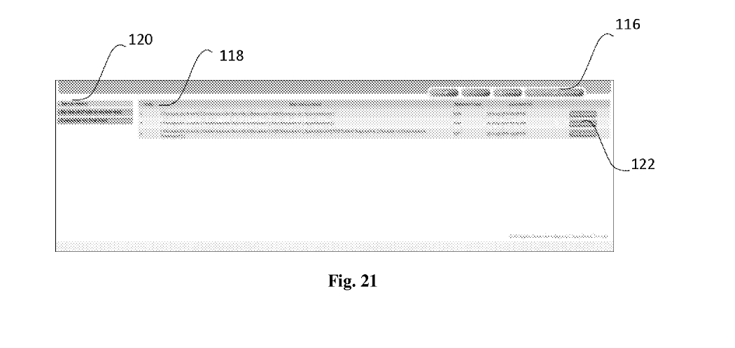

The personalization platform of the tool allows for data export based on the search, and the comparison results of clinical trials can be dynamically exported into a Microsoft Excel file as shown in FIG. 21 and depicted generally by reference numeral 116. Again the tool provides multiple options for example saving search history or trials of interest or setting trial alerts as indicated by reference numeral 120. The search criterion for each search undertaken by the user is shown as indicated by reference numeral 118 and viewing of results option is provided as indicated by reference numeral 122. Thus the User can choose the searches of interest and save for future reference and retrieval.

Further the user can also save and store the search strategy and results in a separate folder for future use. The user can also add comments and extra data to those trials stored in the personal folder.

The personalization platform in one exemplary embodiment also uses user information like age, gender, therapy area of interest, etc to track and monitor usage to personalize the tool including the search query options, display and analytics.

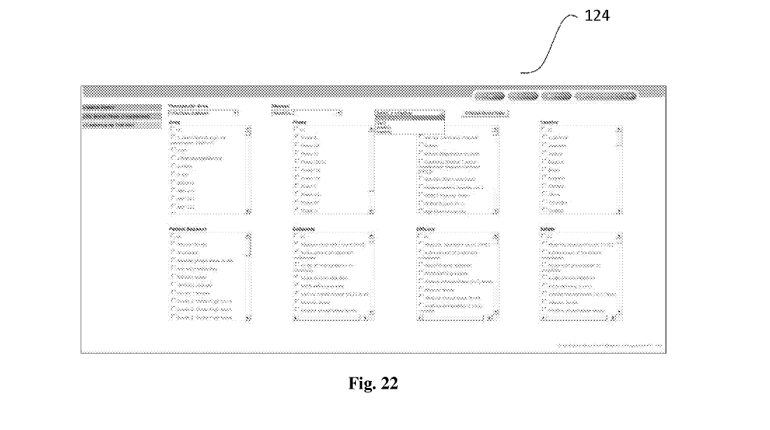

Still further, an email alert option provides the user based on specific parameters such as therapy area, study design, or inclusion criteria, to activate the multiple tagged database to generate automatic mail alerts for updates on clinical trials, this is shown generally by reference numeral 124 in FIG. 22.

One skilled in the art will also appreciate having multiple levels of access to the tool, wherein each level of access gives different levels of control of the tool. Different levels of access include, but not limited to, User, Manager, Administrator, Owner, and the like. In one exemplary embodiment, those having Owner level access can input clinical trial information, update clinical trial information, include new indication parameters and non-indication parameters, and so on; those having Administrator level access can allow new users but cannot change anything related to the multiple tagged database; while those having User level access can only use the search and analysis capabilities. Further levels of access such as Trainees, and the like may become obvious to one skilled in the art. Access to the tool of the invention may be made through a login dialog, which comprises a username and a password. Alternately, login can be made available for a given internet protocol address (also sometimes referred to in the art as IP address).

The tool of the invention may be made available on a subscription on a pay-per-use basis. The tool may also be made available on a trial basis for a predefined period of time. Thus, the tool of the invention comprises a timer which keeps track of the date and time of initial login and accordingly will keep track of when to stop providing access to the tool. Providing a warning to the user regarding the expiry of the subscription at a predefined time prior to the actual expiry date is also contemplated as part of the invention.

Thus, in the exemplary embodiment the clinical trial information tool is a search and analytical tool for analyzing clinical trial information using the above described features of the tool. It will be appreciated by those skilled in the art that the user-interface and the display platform may be integrated into one platform or device such as a screen.

It would be appreciated by those skilled in the art that the tool described herein provides both a repository and an analytical platform of global clinical trials, which would aid in understanding the clinical trial landscape and its competitive environment. It is useful for all those who are involved in design, execution, or analysis of clinical trials and, hence, used by a wide variety of functions such as clinical operations, brand management, competitive intelligence as well as strategic marketing. Thus, the tool may be used in a system for decision making that involves use of clinical trial information.

It may be appreciated by one skilled in the art that the method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application. Similarly a communication link that may be an ordinary link or a dedicated communication link may be provided for accessing the tool as described herein from a user's work station.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A clinical trial information management tool comprising:
an interface with a multiple tagged clinical trial database;
a user interface for receiving user inputs;
a search engine to query the multiple tagged clinical trial database in one or more levels based on user inputs;
a display platform to display results from the query in one or more views;
an analytics engine to provide at least one of parameter based analysis and graphical analysis; and
a personalization platform to store the query and the results.

2. The tool of claim 1 wherein the one or more levels for query comprise a granular search option using predefined clinical parameters.

3. The tool of claim 1 wherein the one or more levels for query comprise a granular search option using predefined clinical sub-parameters.

4. The tool of claim 1 wherein the one or more levels for query comprise use of a boolean operator.

5. The tool of claim 1 wherein the one or more views comprise at least one of a snapshot view, a tabular view, a comparison view, trial map view and a geography map view.

6. The tool of claim 1 wherein the personalized platform comprises a folder option.

7. The tool of claim 1 wherein the personalized platform comprises an export to excel option.

8. The tool of claim 1 wherein the analytics engine provides at least one of a competitive landscape and an individual landscape.

9. A system that comprises the tool of claim 1.

10. A computer program product comprising: a computer useable medium having a computer readable code including instructions for:
interfacing with a multiple tagged clinical trial database;
receiving user inputs;
querying the multiple tagged clinical trial database in one or more levels based on user inputs;
displaying results from the query in one or more views;
analyzing the results to provide at least one of parameter based analysis and graphical analysis; and
storing the query and the results.
